(19) United States
(12) Patent Application Publication
(10) Pub. No.: US 2015/0134376 A1
(43) Pub. Date: May 14, 2015

(54) INFORMATION MANAGEMENT APPARATUS, TERMINAL, AND INFORMATION MANAGEMENT SYSTEM

(71) Applicant: FUJITSU LIMITED, Kawasaki-shi (JP)

(72) Inventors: Taira SHIMA, Kawasaki (JP); Nobutaka Yamamoto, Kawasaki (JP); Tadahiko Sato, inagi (JP); Eiji ITOU, Yokohama (JP)

(21) Appl. No.: 14/520,931

(22) Filed: Oct. 22, 2014

(30) Foreign Application Priority Data
Nov. 11, 2013 (JP) 2013-233526

(51) Int. Cl. G06Q 10/02

(52) U.S. Cl. CPC G06Q 10/02
USPC 705/5

(57) ABSTRACT

A center server includes an application identification information creating unit that allocates, on the basis of communication with a mobile terminal, identification information to an application that is set in the mobile terminal 1; a QR displaying unit that receives an acquisition request for electronic information via the application 10; a ticket displaying unit that creates associated information in which identification information on electronic information is associated with the identification information on the application; and a QR displaying unit that sends, on the basis of the identification information on the application acquired by the acquisition request and the associated information, the electronic information that is associated with the identification information on the application.

### CROSS-REFERENCE TO RELATED APPLICATION(S)

This application is based upon and claims the benefit of priority of the prior Japanese Patent Application No. 2013-233526, filed on Nov. 11, 2013, the entire contents of which are incorporated herein by reference.

### FIELD

The embodiments discussed herein are related to an information management apparatus, a terminal, and an information management system.

### BACKGROUND

In recent years, visible information that is displayed on a displaying unit in an electronic device and that is used for authentication is used as an admission ticket for a concert, an event, or the like. For example, a server that manages ticket information on the admission ticket displays a QR code (registered trademark) as the admission ticket on a mobile terminal.

When the server displays the QR code on the mobile terminal, the server notifies the mobile terminal of, for example, information that is needed to display the QR code by email. Then, the mobile terminal accesses the server in accordance with the information that was received by the email as a notification and allows the server to display the QR code.

However, the information received by email as a notification may possibly be transferred from the mobile terminal that has received the email to another mobile terminal. In other words, the information transferred by email as a notification is indistinguishable, i.e., the information is to be sent to a user of the mobile terminal that received the notification or the information is to be sent to another person. Furthermore, the server does not reject the transferring of the email. Consequently, the mobile terminal at the transfer destination accesses the server in accordance with the information received as a notification by the transferred email and can allow the server to display the QR code without difficulty. Accordingly, a method of displaying a QR code on a valid mobile terminal is needed.

Therefore, there is a conventional known technology in which a server uses the terminal ID of a mobile terminal. In this technology, the server checks whether the terminal ID recorded in a ticket information display application that is received by the mobile terminal matches the terminal ID of the mobile terminal that has received the ticket information display application. If the terminal IDs match, the server displays the ticket information on the display of the mobile terminal (for example, Japanese Laid-open Patent Publication No. 2012-73890).

However, there is a problem in that there may be a case in which the server is not able to send ticket information to a valid mobile terminal. For example, although the terminal ID is uniquely created for a mobile terminal, in some cases, the terminal ID is not able to be used due to reinforcement of personal information or the like. In such a case, the terminal ID is not able to be used on the server side and thus the server is not able to send the ticket information to the valid mobile terminal.

Furthermore, instead of using the terminal ID of the mobile terminal, the server can also use a cookie. However, a cookie can be freely created, but, a cookie is unstable, for example, it disappears or is rewritten. Accordingly, similarly to a case of using the terminal ID, there may be a case in which a server is not able to send ticket information to a valid mobile terminal.

Furthermore, the problem described above is not limited to the ticket information. The same problem occurs as long as identification information that can be displayed on a mobile terminal.

### SUMMARY

According to an aspect of an embodiment, a information management apparatus includes a processor and a memory. The processor executes allocating, on the basis of communication with a terminal, identification information to an application that is set in the terminal. The processor executes receiving an acquisition request for electronic information via the application. The processor executes creating associated information in which identification information on the electronic information is associated with the identification information on the application. The processor executes sending, on the basis of the identification information on the application acquired by the acquisition request and the associated information, the electronic information associated with the identification information on the application.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the configuration of a ticket information management system according to a first embodiment;

FIG. 2 is a schematic diagram illustrating an example of the data structure of an application identification information DB according to the first embodiment;

FIG. 3 is a schematic diagram illustrating an example of the data structure of a ticket information DB according to the first embodiment;

FIG. 4 is a schematic diagram illustrating an example of the data structure of a user information DB according to the first embodiment;

FIG. 5 is a schematic diagram illustrating the sequence of an application initial start up process according to the first embodiment;

FIG. 6 is a schematic diagram illustrating the sequence of a QR displaying process according to the first embodiment;

FIG. 7 is a schematic diagram illustrating the transition of data when the application initial start up process according to the first embodiment is performed;

FIG. 8 is a schematic diagram illustrating the transition of data when the QR displaying process according to the first embodiment is performed;

FIG. 9 is a block diagram illustrating the configuration of a ticket information management system according to a second embodiment;

FIG. 10 is a schematic diagram illustrating an example of the data structure of a target user information DB according to the second embodiment;

FIG. 11 is a schematic diagram illustrating the sequence of a QR displaying process according to the second embodiment; and

FIG. 12 is a schematic diagram illustrating the transition of data when the QR displaying process according to the second embodiment is performed.

### DESCRIPTION OF EMBODIMENTS

Preferred embodiments of the present invention will be explained with reference to accompanying drawings. The present invention is not limited to the embodiments.

### [a] First Embodiment

Configuration of a Ticket Information Management System

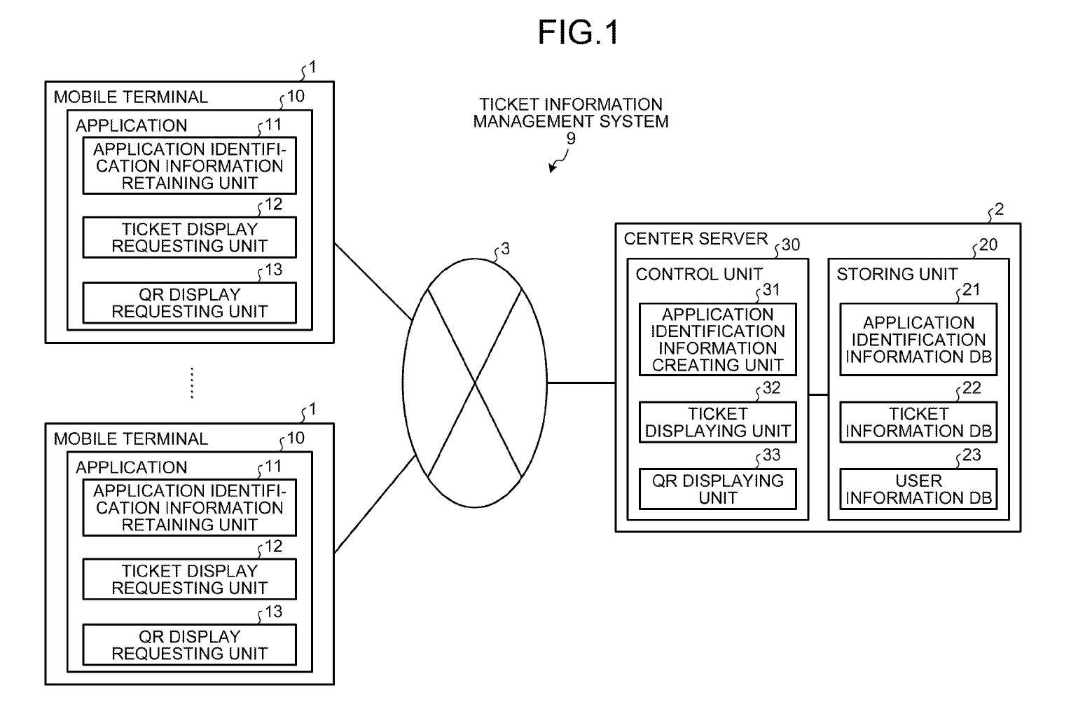

FIG. 1 is a block diagram illustrating the configuration of a ticket information management system according to a first embodiment. As illustrated in FIG. 1, a ticket information management system 9 is a system that manages ticket information on an admission ticket for a concert, an event, or the like and includes mobile terminals 1 and a center server 2. The center server 2 is connected to the multiple mobile terminals 1 via a network 3 that indicates, for example, an Internet network.

An application 10 is set in each of the mobile terminals 1. The application 10 is an application that is used to display a ticket or a QR code. The QR code is visible information that is used for authentication at the time of admission. The application 10 is downloaded from the site that is used to purchase, for example, the ticket. The site that is used to purchase a ticket may also be the center server 2. An application identification number that is an identification number for identifying the application 10 is not set in the application 10 immediately after the application 10 is downloaded. When the application identification number is set in the application 10 by an application identification information retaining unit 11, which will be described later, it is possible to identify the applications 10 downloaded to the mobile terminal 1 that is used to purchase the ticket. The application 10 includes the application identification information retaining unit 11, a ticket display requesting unit 12, and a QR display requesting unit 13. The application identification information retaining unit 11 is an example of an acquiring unit and a retaining unit. The QR display requesting unit 13 is an example of a requesting unit.

The application identification information retaining unit 11 acquires, via communication with the center server 2, an application identification number that is an identification number for identifying the application 10 that is set in the mobile terminal 1. Then, the application identification information retaining unit 11 stores the acquired application identification number in a storage area of the application 10.

For example, at the time of initial start up that is performed after the application 10 is downloaded, the application identification information retaining unit 11 sends, to the center server 2, an acquisition request for an application identification number of the application 10. Then, the application identification information retaining unit 11 stores, in a storage area of the application 10, the application identification number that is returned from the center server 2. In other words, when the application 10 is started up, the application identification information retaining unit 11 accesses the center server 2 and allows the center server 2 to allocate an identification number to the application 10, thereby making the center server 2 identify the applications 10. In other words, the application identification information retaining unit 11 can allow the center server 2 to identify the applications 10 without using an identification number of the mobile terminal 1 or a cookie.

The ticket display requesting unit 12 sends login information and an application identification number to the center server 2 and inquires about login authentication.

Furthermore, if the login authentication is successful, the ticket display requesting unit 12 allows the center server 2 to display the list of tickets that are currently retained. For example, the ticket display requesting unit 12 sends, to the center server 2, a display request for the list of tickets including therein the login information and application identification numbers. The ticket display requesting unit 12 displays, by using the center server 2, the list of the tickets that match the login information and the application identification number. At this point, for example, a user ID or the like that is the identification ID (identification) of a user is included in the login information. If a ticket is, for example, an admission ticket for a concert, the type name of a seat (seat type name), the floor number of the seat, and the seat number are included in the list information of the ticket. Even if the mobile terminal 1 sends a display request for a QR code that includes the same login information as that used by another mobile terminal 1, the QR code that matches the login information is not displayed. This is because the application identification numbers of the applications 10 set in the mobile terminals 1 differ.

The QR display requesting unit 13 displays, by using the center server 2, the QR code of the currently retained ticket. For example, the QR display requesting unit 13 sends, to the center server 2, a display request for a QR code that includes information on the ticket, the login information, and an application identification number selected from the ticket list that is displayed by the ticket display requesting unit 12. The QR display requesting unit 13 displays, by using the center server 2, the QR code that matches the login information and the application identification number. Furthermore, even if the mobile terminal 1 sends a display request for a QR code that includes the same login information as that of the other mobile terminal 1, the QR code that matches the login information is not displayed. This is because application identification numbers of the applications 10 that are set in the mobile terminals 1 differ.

The center server 2 includes a storing unit 20 and a control unit 30. The storing unit 20 corresponds to a nonvolatile semiconductor memory device, such as a flash memory, a ferroelectric random access memory (FRAM) (registered trademark) or corresponds to a storage device, such as a magnetic disk, or the like. Then, the storing unit 20 includes an application identification information database (DB) 21, a ticket information DB 22, and a user information DB 23.

The application identification information DB 21 stores therein application identification information, for each of the applications 10, that is set in each of the mobile terminals 1. The application identification information mentioned here is an identification number (application identification number) that is used to identify the application 10; however, the application identification information is not limited to the identification number. For example, any identifier that can be used to identify the application 10 may also be used. The ticket information DB 22 manages ticket information that includes a QR code. The user information DB 23 stores therein user information in which users are associated with application identification numbers. The data structure of each of the application identification information DB 21, the ticket information DB 22, and the user information DB 23 will be described later.

The control unit 30 includes an internal memory that stores therein control data and programs that prescribe various kinds of procedures, whereby various kinds of processes are executed. Furthermore, the control unit 30 corresponds to an integrated circuit, such as an application specific integrated circuit (ASIC), a field programmable gate array (FPGA), and the like or corresponds to an electronic circuit, such as a central processing unit (CPU), a micro processing unit (MPU), and the like. Furthermore, the control unit 30 includes an application identification information creating unit 31, a ticket displaying unit 32, and a QR displaying unit 33. The application identification information creating unit 31 is an example of an allocating unit and an identification information sending unit. The ticket displaying unit 32 is an example of a creating unit. The QR displaying unit 33 is an example of a sending unit, a determining unit, and an electronic information sending unit.

If input information that is input by the application 10 via communication with the application 10 that is set in the mobile terminal 1 indicates first information, the application identification information creating unit 31 creates an application identification number that is used to identify the target application 10. The first information mentioned here is, for example, null. For example, if the application identification information creating unit 31 receives an acquisition request for the application identification information from the application 10 that is set in the mobile terminal 1, the application identification information creating unit 31 allocates an application identification number that is used to identify the application 10 that is set in the other mobile terminal 1. The application identification information creating unit 31 stores the allocated application identification number in the application identification information DB 21. Then, the application identification information creating unit 31 returns the allocated application identification number to the application 10 that is set in the mobile terminal 1 that is the request source.

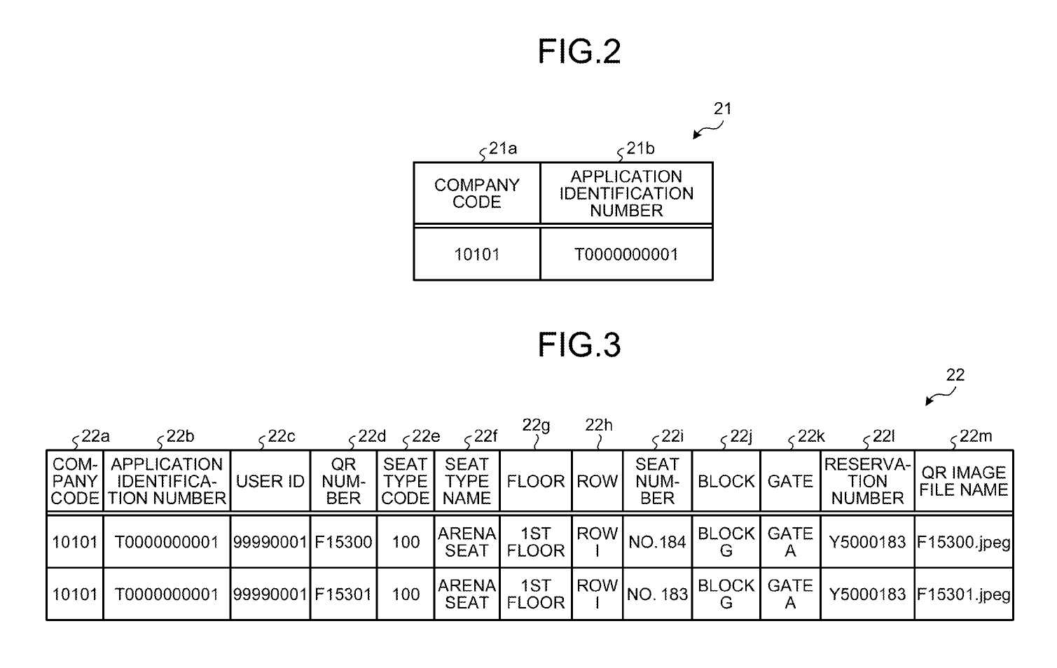

In the following, the data structure of the application identification information DB 21 will be described with reference to FIG. 2. FIG. 2 is a schematic diagram illustrating an example of the data structure of an application identification information DB according to the first embodiment. As illustrated in FIG. 2, the application identification information DB 21 stores therein, in an associated manner, a company code 21a and an application identification number 21b. The company code 21a is a code for identifying a company. The application identification number 21b is an application identification number that is created by the application identification information creating unit 31. For example, if the company code 21a is “10101”, the application identification information DB 21 stores therein “T0000000001” as the application identification number 21b.

A description will be given here by referring back to FIG. 1. If an application identification number is included in the input information that is input by the application 10 via the communication with the application 10, the ticket displaying unit 32 displays ticket information that is associated with the application identification number on the application 10 that is the communication source.

For example, if the ticket displaying unit 32 receives an inquiry about login authentication from the application 10, the ticket displaying unit 32 performs the login authentication. For example, by using the application identification information DB 21 and the user information DB 23, the ticket displaying unit 32 performs the login authentication by using the application identification number and the login information as a key. If the login authentication is successful, the ticket displaying unit 32 updates the application identification number stored in the user information in the user information DB 23. Furthermore, the ticket displaying unit 32 searches, by using the login information as a key, the ticket information DB 22 for ticket information and then updates the application identification number stored in the searched ticket information. Specifically, the ticket displaying unit 32 links the ticket information searched from the ticket information DB 22 with the application identification number.

Furthermore, if the ticket displaying unit 32 receives a display request for the ticket list from the application 10, the ticket displaying unit 32 displays the list of tickets that are associated with the application identification numbers of the applications 10 on the monitor of the mobile terminal 1 in which the application 10 is set. For example, the ticket displaying unit 32 determines whether the login information and the application identification number included in the display request for the list of tickets matches one of the pieces of the ticket information stored in the ticket information DB 22. If the login information and the application identification number included in the display request for the ticket list matches one of the pieces of the ticket information stored in the ticket information DB 22, the ticket displaying unit 32 displays the matched ticket information on the monitor of the mobile terminal 1 that is the request source. In contrast, if the login information and the application identification number included in the display request for the ticket list do not match any of the ticket information stored in the ticket information DB 22, the ticket displaying unit 32 does not display the ticket information on the monitor of the mobile terminal 1 that is the request source. Namely, the ticket displaying unit 32 displays only the ticket information that matches the login information (user ID) and the application identification number on the mobile terminal 1 in which the application 10 with the target application identification number is set. In other words, the ticket displaying unit 32 does not display the ticket information that matches the login information on the mobile terminal 1 that has a different application identification number even if the mobile terminal 1 has the same login information (user ID). This is because application identification numbers of the applications 10 set in the mobile terminals 1 differ.

If an application identification number is included in the input information that is input by the application 10 via communication with the application 10, the QR displaying unit 33 displays the QR code of the ticket information that is associated with the target application identification number on the application 10 that is the communication source.

For example, if the QR displaying unit 33 receives, from the application 10, a display request for a QR code related to the selected ticket, the QR displaying unit 33 displays the QR code of the ticket information associated with the application identification number of the application 10 on the monitor of the mobile terminal 1 that is the request source. For example, the QR displaying unit 33 determines whether the login information and the application identification number included in the display request for the QR code matches the ticket information on the selected ticket from among the pieces of the ticket information stored in the ticket information DB 22. If the login information and the application identification number included in the display request for the QR code matches the ticket information on the selected ticket from among the pieces of the ticket information stored in the ticket information DB 22, the QR displaying unit 33 displays the QR code of the matched ticket information on the monitor of the mobile terminal 1 that is the request source. In contrast, if the login information and the application identification number included in the display request for the QR code do not match the ticket information on the selected ticket from among the pieces of the ticket information stored in the ticket information DB 22, the QR displaying unit 33 does not display the QR code of the ticket information on the monitor of the mobile terminal 1 that is the request source. Namely, the QR displaying unit 33 displays only the QR code of the ticket information that includes therein the matched the login information (user ID) and the application identification number on the mobile terminal 1 in which the application 10 with the target application identification number is set. In other words, the QR displaying unit 33 does not display the QR code of the ticket information that matches the login information on the mobile terminal 1 that has a different application identification number even if the mobile terminal 1 has the same login information (user ID). This is because the application identification numbers of the applications 10 that are set in the mobile terminals 1 differ.

In the following, the data structure of the ticket information DB 22 will be described with reference to FIG. 3. FIG. 3 is a schematic diagram illustrating an example of the data structure of a ticket information DB according to the first embodiment. As illustrated in FIG. 3, the ticket information DB 22 stores therein, in an associated manner, a company code 22a, an application identification number 22b, a user ID 22c, and a QR number 22d. Furthermore, the ticket information DB 22 stores therein, in an associated manner, a seat type code 22e, a seat type name 22f, a floor 22g, a row 22h, a seat number 22i, a block 22j, a gate 22k, a reservation number 22l, and a QR image file name 22m.

The company code 22a is a code for identifying a company. The application identification number 22b is an application identification number that is set by the ticket displaying unit 32. The user ID 22c is an ID for identifying a user. The QR number 22d indicates a QR code number that is associated with the ticket alternative to a paper ticket. The seat type code 22e indicates a code representing the type of seat. The seat type name 22f indicates the name of the seat type. The floor 22g indicates the floor number on which a seat is located. The row 22h indicates the row number in which a seat is located. The seat number 22i indicates the seat number. The block 22j indicates the block number in which a seat is present when seats are grouped for each block. The gate 22k indicates an entrance gate. The reservation number 22l indicates the reservation number obtained when a ticket is purchased. The QR image file name 22m is the name of a file when a QR image is stored. Furthermore, in the ticket information DB 22, ticket information other than the application identification number 22b is set when a user purchases a ticket.

For example, if the seat type code 22e is “100, the seat type name 22f is an “arena seat”, the floor 22g is the “1^{st} floor”, the row 22h is “row I”, the seat number 22i is “No. 184”, the ticket information DB 22 stores therein “T0000000001” as the application identification number 22b. Furthermore, the ticket information DB 22 stores therein “10101” as the company code 22a, “99990001” as the user ID 22c, “F15300” as the QR number 22d, and “F15300.jpeg” as the QR image file name 22m.

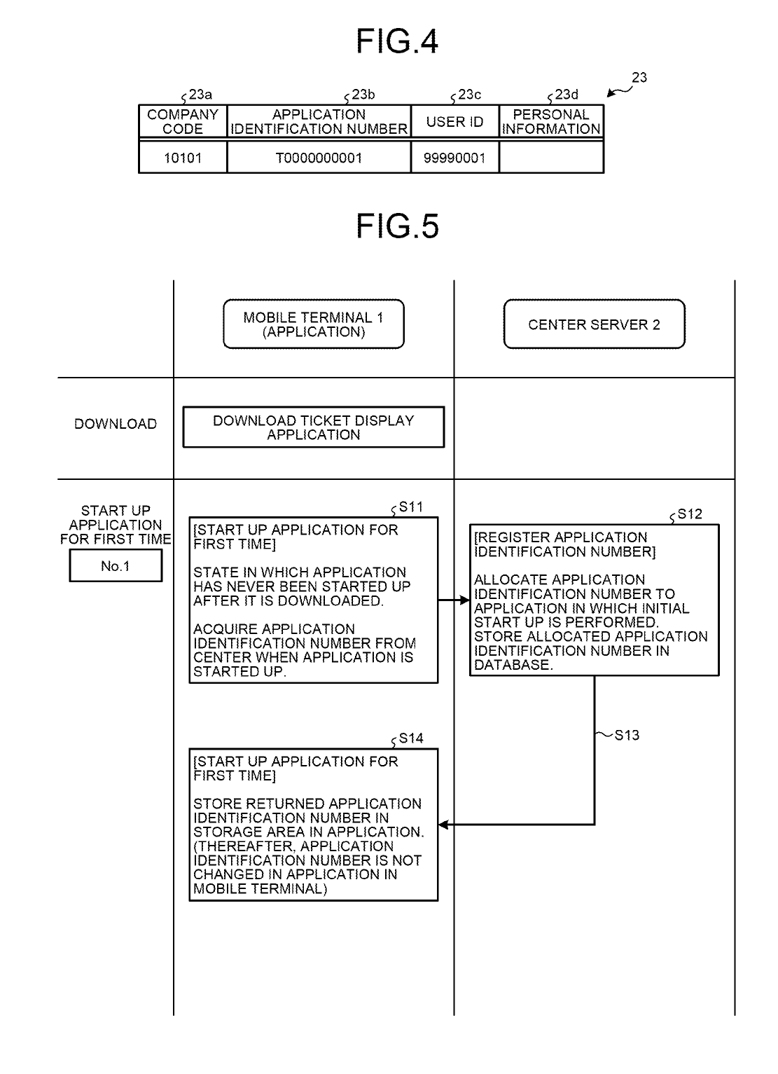

In the following, the data structure of the user information DB 23 will be described with reference to FIG. 4. FIG. 4 is a schematic diagram illustrating an example of the data structure of a user information DB according to the first embodiment. As illustrated in FIG. 4, the user information DB 23 stores therein, in an associated manner, a company code 23a, an application identification number 23b, a user ID 23c, and personal information 23d. The company code 23a is a code for identifying a company. The application identification number 23b is an application identification number that is set by the ticket displaying unit 32. The user ID 23c is an ID for identifying a user. The personal information 23d is personal information on a user that is associated with the user ID 23c. Furthermore, when a user purchases a ticket, user information other than the application identification number 23b is set in the user information DB 23.

For example, if the user ID 23c is “99990001”, the user information DB 23 stores therein “10101” as the company code 23a and “T0000000001” as the application identification number 23b.

Sequence of an Application Initial Start Up Process

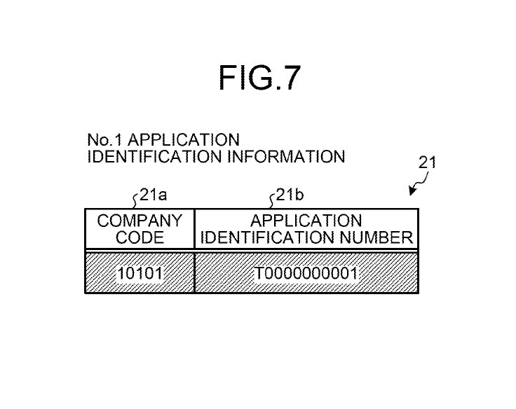

In the following, the sequence of an application initial start up process will be described by appropriately using the content of data stored in the various DBs. FIG. 5 is a schematic diagram illustrating the sequence of the application initial start up process according to the first embodiment. It is assumed that the mobile terminal 1 has downloaded the application 10 that displays a ticket and a QR code. Furthermore, in below, a description will be given by appropriately using the records stored in the application identification information DB 21 illustrated in FIG. 7.

After the mobile terminal 1 downloaded the application 10, the application 10 is started up for the first time. Then, the application identification information retaining unit 11 in the application 10 sends, to the center server 2, an acquisition request for an application identification number that is used to identify the application 10 (Step S11). For example, a company code and null that indicates that the start up is the first time are set in input information on the acquisition request for the application identification number.

In the center server 2, if the application identification information creating unit 31 receives the acquisition request for the application identification number from the application 10 in the mobile terminal 1, the application identification information creating unit 31 allocates an application identification number to the application 10 in which the initial start up is performed. The application identification number is the identification number that is used to identify the application 10 downloaded by the other mobile terminal 1. Then, the application identification information creating unit 31 stores the allocated application identification number in the application identification information DB (Step S12). In this case, in the record in the application identification information DB 21, “10101” is set as the company code 21a and “T0000000001” is set as the application identification number 21b (see No. 1 of FIG. 7).

Then, the application identification information creating unit 31 returns the allocated application identification number to the application 10 that is set in the mobile terminal 1 that is the request source (Step S13).

In the mobile terminal 1, the application identification information retaining unit 11 in the application 10 stores the returned application identification number in the storage area in the application 10 (Step S14). Thereafter, the application identification number is not changed in the application 10 in the mobile terminal 1. Consequently, the mobile terminal 1 can communicate with the center server 2 by using the application identification number and can allow the center server 2 to identify the applications 10.

Sequence of a QR Displaying Process

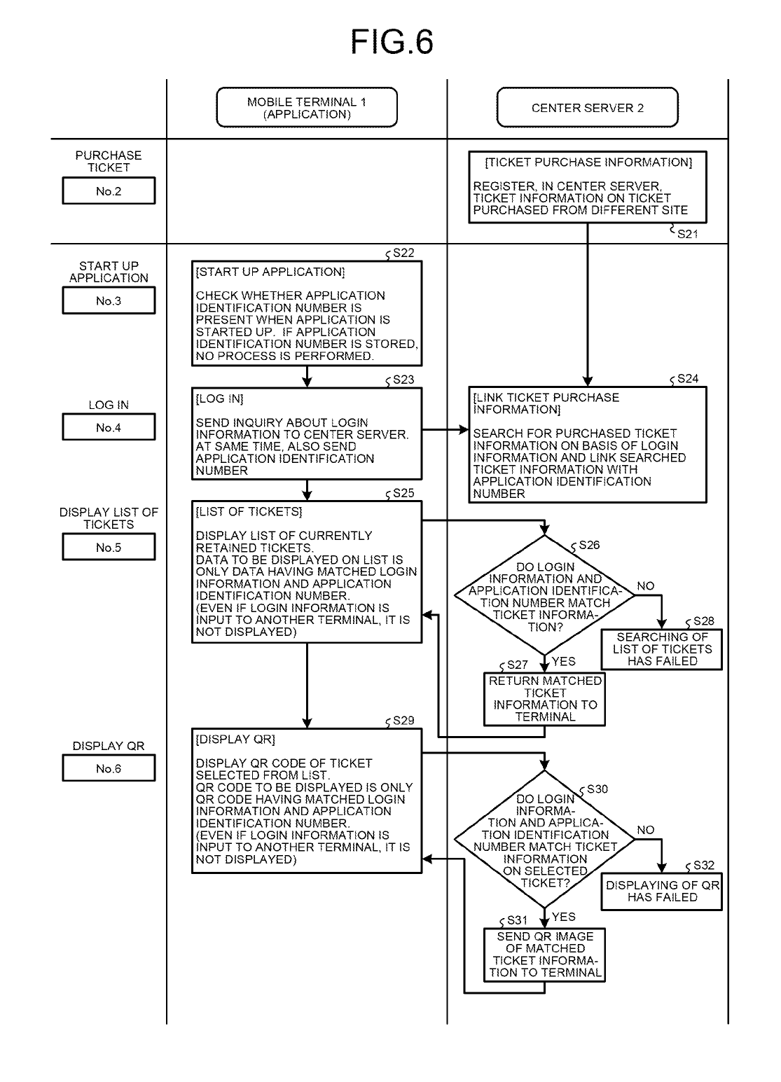

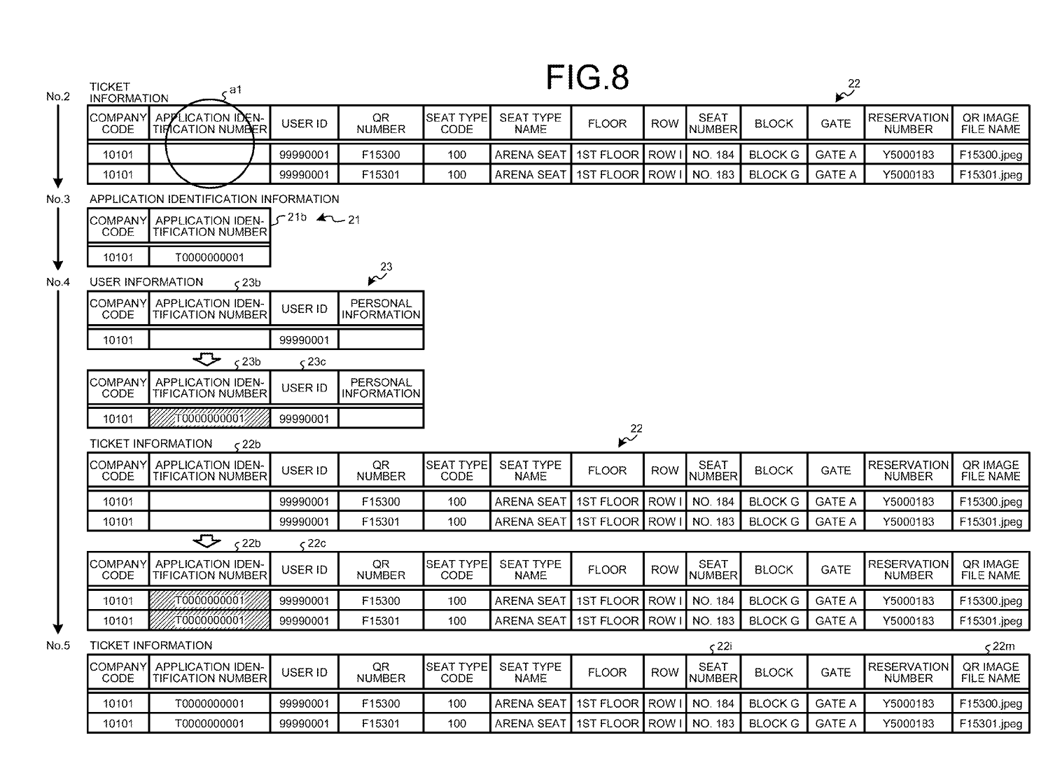

In the following, the sequence of a QR displaying process will be described by appropriately using the content of data in the various DBs. FIG. 6 is a schematic diagram illustrating the sequence of the QR displaying process according to the first embodiment. Furthermore, in below, a description will be given by appropriately using the records stored in the ticket information DB 22, the application identification information DB 21, and the user information DB 23 illustrated in FIG. 8. In this example, it is assumed that the user ID of the user who purchased a ticket by using the mobile terminal 1 is “99990001” and the application identification number of the application 10 that displays the ticket is “T0000000001”. An application identification number is set in the storage area in the application 10.

First, the center server 2 registers, in the ticket information DB 22, ticket information on the ticket purchased by a user at the site that is different from the center server 2 (Step S21). At this point, an application identification number al has not yet been set in the ticket information registered in the ticket information DB 22 (see No. 2 of FIG. 8). Furthermore, the center server 2 registers information on the user who has purchased the ticket in the user information DB 23 (not illustrated).

First, the application 10 is started up in the mobile terminal 1. Then, the application 10 refers to the storage area and checks whether an application identification number is present. If an application identification number is stored, the application 10 does not perform any process (Step S22). In this case, because the application identification number is stored, the application 10 does not perform any process. At this point, in the application identification information DB 21 in the center server 2, the application identification number 21b of the application 10 has already been set (No. 3 of FIG. 8).

Then, in the mobile terminal 1, if login information is input, the ticket display requesting unit 12 sends, to the center server 2, the input login information and the application identification number that is stored in the storage area and then inquires about login authentication (Step S23). The login information includes therein, for example, the user ID.

In the center server 2, when the ticket displaying unit 32 receives the inquiry about the login authentication, the ticket displaying unit 32 performs the login authentication by using the login information and the application identification number. If the login authentication is successful, the ticket displaying unit 32 updates the application identification number in the user information that is associated with the target user ID in the user information DB 23. Furthermore, the ticket displaying unit 32 searches, on the basis of the login information, the ticket information DB 22 for ticket information and then links the searched ticket information with the application identification number (Step S24). In this example, in the user information DB 23, “T0000000001” is set in the application identification number 23b for the user with the user ID 23c of “99990001” (No. 4 of FIG. 8). In the ticket information DB 22, “T0000000001” is set in the application identification number 22b for the user with the user ID 22c of “99990001” (No. 4 of FIG. 8).

Subsequently, in the mobile terminal 1, when the ticket display requesting unit 12 receives a notification indicating that the login authentication has been successful, the ticket display requesting unit 12 sends a display request for a ticket list in order to display the list of the currently retained tickets (Step S25). The login information and the application identification number are included in the display request for the ticket list.

In the center server 2, when the ticket displaying unit 32 receives the display request for the ticket list, the ticket displaying unit 32 determines whether the login information and the application identification number included in the request match one of the pieces of the ticket information stored in the ticket information DB 22 (Step S26). If it is determined that the login information and the application identification number included in the request match one of the pieces of the ticket information stored in the ticket information DB 22 (Yes at Step S26), the ticket displaying unit 32 performs the following process. Namely, the ticket displaying unit 32 returns the ticket information that matches the login information and the application identification number to the mobile terminal (Step S27).

In contrast, if it is determined that the login information and the application identification number included in the request do not match any of the ticket information stored in the ticket information DB 22 (No at Step S26), the ticket displaying unit 32 determines that the searching of the ticket list has failed (Step S28) and does not return the ticket information to the mobile terminal 1.

In the following, a description will be given with reference to No. 5 of FIG. 8. Because the user ID included in the login information is “99990001” and the application identification number is “T0000000001”, the ticket displaying unit 32 determines that the seat number 22i matches two pieces of the ticket information that indicate “No. 184” and “No. 183”. Then, the ticket displaying unit 32 returns the matched ticket information to the mobile terminal 1 that is the request source. Namely, the ticket displaying unit 32 displays the list of the matched ticket information on the monitor of the mobile terminal 1 that is the request source.

Then, in the mobile terminal 1, if the ticket information is selected from the list of the ticket information displayed on the monitor, the QR display requesting unit 13 sends a display request of a QR code in order to display the QR code of the ticket information selected by the user (Step S29). In addition to the login information and the application identification number, the selected ticket information is included in the display request for the QR code.

In the center server 2, the QR displaying unit 33 receives the display request for the QR code. Then, the QR displaying unit 33 determines whether login information and the application identification number included in the request match the login information and the application identification number of the selected ticket information stored in the ticket information DB 22 (Step S30). If it is determined that login information and the application identification number included in the request match the login information and the application identification number of the selected ticket information stored in the ticket information DB 22 (Yes at Step S30), the QR displaying unit 33 performs the following process. Namely, the QR displaying unit 33 returns the QR image of the selected ticket information to the mobile terminal 1 (Step S31).

In contrast, if it is determined that login information and the application identification number included in the request do not match the login information and the application identification number of the selected ticket information stored in the ticket information DB 22 (No at Step S30), the QR displaying unit 33 determines that the displaying of the QR has failed (Step S32) and does not return the QR image to the mobile terminal 1.

In the following, a description will be given with reference to No. 5 of FIG. 8. If it is assumed that the seat number indicated by the selected ticket information is “No. 183”, the QR displaying unit 33 returns the QR image of the QR image file name 22m “F15301.jpeg” that is associated with the seat number 22i to the mobile terminal 1 that is the request source. Namely, the QR displaying unit 33 displays the QR image of the selected ticket information on the monitor of the mobile terminal 1 that is the request source.

In the first embodiment, a description has been given of a case in which an application identification number is not set in the downloaded application 10. However, an application identification number may also be set in the downloaded application 10. For example, if the center server 2 corresponds to the site from which a ticket is purchased, the center server 2 may also download, to the mobile terminal 1, the application 10 in which an application identification number is set. Specifically, when a purchase request for a ticket is received from the mobile terminal 1, the application identification information creating unit 31 in the center server 2 allocates the application identification number of the application 10 that displays both the ticket and the QR code and then downloads, to the mobile terminal 1, the application 10 in which the allocated application identification number is embedded. Furthermore, the application identification information creating unit 31 adds the allocated application identification number to the application identification information DB 21. For the ticket information DB 22, the application identification information creating unit 31 stores the allocated application identification number in the application identification number 22b that is associated with the ticket information on the purchased ticket. For the user information DB 23, the application identification information creating unit 31 stores the allocated application identification number in the application identification number 23b that is associated with the user information on the user who purchased the ticket.

Advantage of the First Embodiment

According to the first embodiment, on the basis of communication with the mobile terminal 1, the center server 2 allocates an application identification number to the application 10 that is set in the mobile terminal 1. The center server 2 receives a display request for an electronic ticket via the application 10. The center server 2 creates associated information in which the identification information on the electronic ticket is associated with the identification number of the application 10. Then, on the basis of the identification number of the application 10 acquired by the display request and the associated information, the center server 2 sends the electronic ticket that is associated with the identification number of the application 10. With this configuration, the center server 2 allocates the application identification number to the application 10 that is set in the mobile terminal 1. Accordingly, in response to the display request for the electronic ticket received from the mobile terminal 1 via the application 10, the center server 2 can send the target electronic ticket by using the application identification number. Consequently, the center server 2 can send the electronic ticket after checking the validity of the mobile terminal 1 in which the application 10 is set.

Furthermore, according to the first embodiment, the center server 2 creates associated information in which an electronic ticket that is associated with authentication information acquired by a display request for the electronic ticket is associated with an application identification number of the application 10 acquired by the display request for the electronic ticket. With this configuration, by using the application identification number, the center server 2 can associate the electronic ticket that is associated with the authentication information with the application 10, i.e., the mobile terminal 1 in which the application 10 is set.

Furthermore, according to the first embodiment, the center server 2 determines whether an application identification number acquired by a display request for an electronic ticket matches one of the application identification numbers associated with the associated information. If the determination result indicates that the application identification number matches one of the application identification numbers associated with the associated information, the center server 2 sends the electronic ticket that is associated with the matched application identification number to the mobile terminal 1 in which the application 10 is set. With this configuration, because the center server 2 can identify the application 10 that is the request source by using the application identification number, the center server 2 can send the electronic ticket that is associated with the application identification number to the valid application 10. In other words, because the center server 2 can identify, by using the application identification number, the mobile terminal 1 in which the application 10 that is the request source is set, the center server 2 can send the electronic ticket associated with the application identification number to the valid mobile terminal 1.

Furthermore, according to the first embodiment, if the application identification number acquired by the display request for the electronic ticket does not match any of the application identification numbers associated with the associated information, the center server 2 does not send any electronic ticket to the mobile terminal 1 that is the send source of the display request. With this configuration, because the center server 2 can identify the application 10 that is the request source by using the application identification number, the center server 2 can prevent the electronic ticket from being sent to the application 10 that is invalid. In other words, because the center server 2 can identify, by using the application identification numbers, the mobile terminal 1 in which the application 10 that is the request source is set, the center server 2 can prevent the electronic ticket from being sent to the mobile terminal 1 that is invalid.

Furthermore, according to the first embodiment, the center server 2 sends the allocated application identification number to the mobile terminal 1 in which the application 10 is set. With this configuration, the center server 2 can send an access request received from the mobile terminal 1 after the center server 2 has sent the allocated application identification number by using the application identification number. Consequently, the center server 2 can check that the access request received from the mobile terminal 1 is an access request from the mobile terminal 1 that is valid.

### [b] Second Embodiment

In the first embodiment, a description has been given of a case in which, in the ticket information management system 9 according to the first embodiment, when a user purchases a ticket, the user who purchased the ticket displays the QR code of the purchased ticket. However, in the ticket information management system 9, the configuration is not limited thereto. For example, there may also be a case in which users who were invited from among the users who purchased tickets in the past receive tickets on a first-come-first-served basis up to a predetermined number of users and each of the users displays the QR code of the received ticket.

Accordingly, in the following, a description will be given of a case in which, in the ticket information management system 9 according to a second embodiment, users who were invited from the users who purchased tickets in the past receive, on a first-come-first-served basis, tickets the number of which is up to a predetermined number of users and each of the users displays the QR code of the received ticket.

Ticket Information Management System According to the Second Embodiment

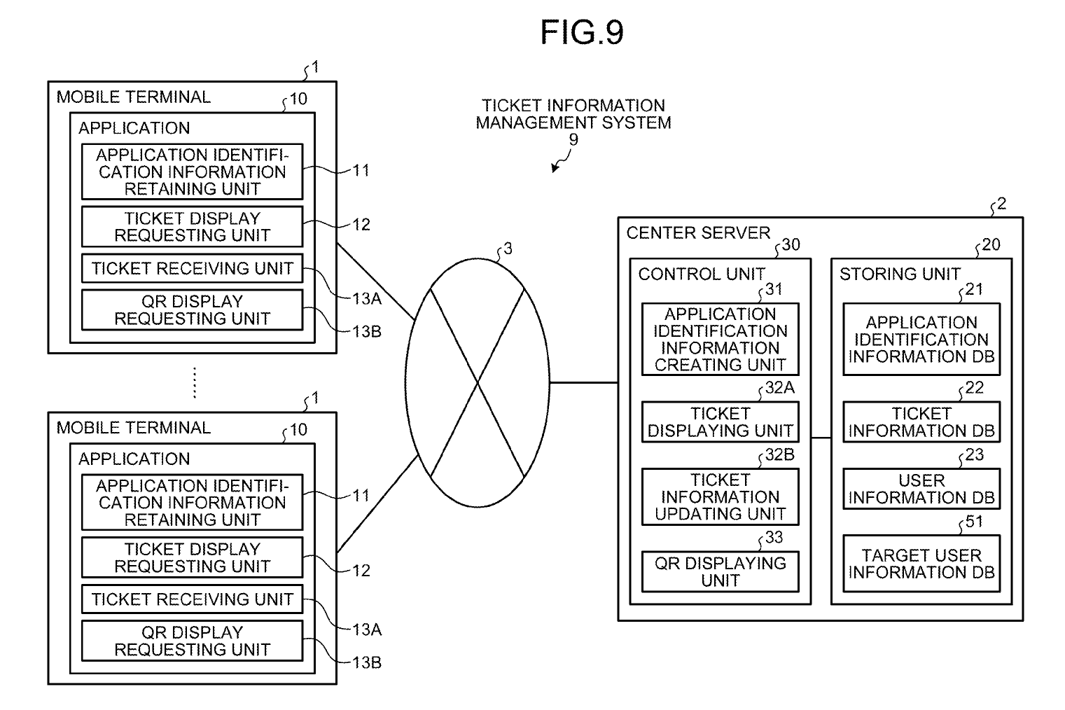

FIG. 9 is a block diagram illustrating the configuration of a ticket information management system according to the second embodiment. Components having the same configuration as those in the ticket information management system 9 illustrated in FIG. 1 are assigned the same reference numerals; therefore, descriptions thereof will be omitted. The second embodiment differs from the first embodiment in that a ticket receiving unit 13A is added to the application 10 in the mobile terminal 1. The second embodiment differs from the first embodiment in that the QR display requesting unit 13 in the application 10 in the mobile terminal 1 is changed to a QR display requesting unit 13B. The second embodiment differs from the first embodiment in that a target user information DB 51 is added to the storing unit 20 in the center server 2. The second embodiment differs from the first embodiment in that a ticket information updating unit 32B is added to the control unit 30 in the center server 2. The second embodiment differs from the first embodiment in that the ticket displaying unit 32 in the control unit 30 in the center server 2 is changed to a ticket displaying unit 32A. Furthermore, the ticket information updating unit 32B is an example of an updating unit.

The ticket receiving unit 13A receives a ticket that is to be received. For example, the ticket receiving unit 13A sends, to the center server 2, a receipt request for a ticket including the information, the login information, and the application identification number of the ticket selected from the ticket list displayed by the ticket display requesting unit 12. Furthermore, the ticket receiving unit 13A allows the center server 2 to change the displayed status about the selected ticket from the not-yet received state to the received state.

The QR display requesting unit 13B sends, to the center server 2, a display request for the QR code including the information, the login information, and the application identification number of the ticket that is displayed as the received state by the ticket receiving unit 13A. The QR display requesting unit 13B allows the center server 2 to display the QR code that matches the login information and the application identification number. Even if the mobile terminal 1 sends a display request for the QR code that includes the same login information as that of the other mobile terminal 1, the QR code that matches the login information is not displayed. This is because the application identification numbers of the applications 10 that are set in the mobile terminals 1 differ.

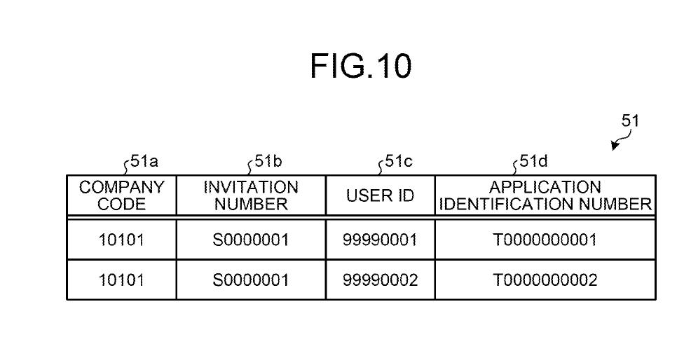

The target user information DB 51 stores therein information on target users who can receive tickets. In the following, the data structure of the target user information DB 51 will be described with reference to FIG. 10. FIG. 10 is a schematic diagram illustrating an example of the data structure of the target user information DB according to the second embodiment. The target user information DB 51 stores therein, in an associated manner, a company code 51a, an invitation number 51b, a user ID 51c, and an application identification number 51d. The company code 51a is a code for identifying a company. The invitation number 51b is a number that is associated with a user invited from among the users who purchased tickets in the past. The user ID 51c is the ID for identifying a user. The application identification number 51d is an identification number that is used to identify the application 10 that is set in the mobile terminal 1 used by the user associated with the user ID 51c. Specifically, the application 10 that displays both the ticket and the QR code of the ticket is set in the mobile terminal 1 that is used by the user who purchased the ticket in the past. Furthermore, an application identification number is stored in the storage area in the application 10.

For example, if the company code 51a is “10101”, the target user information DB 51 stores therein “S0000001” as the invitation number 51b, “99990001” as the user ID 51c, and “T0000000001” as the application identification number 51d.

If the ticket displaying unit 32A receives an inquiry about login authentication from the application 10, the ticket displaying unit 32A performs the login authentication. For example, by using the application identification information DB 21 and the user information DB 23, the ticket displaying unit 32A performs the login authentication by using the application identification number and the login information included in the inquiry as a key.

Furthermore, if the ticket displaying unit 32A receives, from the application 10, a display request for the list of the tickets that can be received, the ticket displaying unit 32A displays the list of the tickets from which the application identification number of the application 10 can be received on the monitor on the mobile terminal 1 in which the application 10 is set. For example, the ticket displaying unit 32A determines whether the login information and the application identification number included in the display request for the list of the tickets that can be received match any of the target user information stored in the target user information DB 51. If the login information and the application identification number included in the display request for the list of the tickets that can be received match any of the target user information stored in the target user information DB 51, the ticket displaying unit 32A, performs the following process. Namely, if ticket information that has not been received is present in the ticket information that is previously registered and that is used for the invitation, the ticket displaying unit 32A displays the target ticket information on the monitor of the mobile terminal 1 that is the request source. In contrast, if login information and the application identification number do not match any of the target user information stored in the target user information DB 51, the ticket displaying unit 32A does not display the ticket information on the monitor of the mobile terminal 1 that is the request source. Namely, the ticket displaying unit 32A displays only the ticket information that includes therein the matched login information (user ID) and the application identification number on the mobile terminal 1 in which the application 10 of the target application identification number is set. In other words, the ticket displaying unit 32A does not display the ticket information that matches the login information on the mobile terminal 1 that has a different application identification number even if the mobile terminal 1 has the same login information (user ID). This is because the application identification numbers of the applications 10 that are set in the mobile terminals 1 differ.

When the ticket information updating unit 32B receives a receipt request for a ticket from the application 10, for the ticket information DB 22, the ticket information updating unit 32B updates the application identification number and the user ID in the ticket information on the ticket requested by the receipt request. The receipt request for the ticket includes therein the login information and the application identification number. Furthermore, for the ticket that is requested by the receipt request, the ticket information updating unit 32B changes the status displayed on the monitor of the mobile terminal 1 from the not-yet received state to the received state.

Sequence of the QR Displaying Process

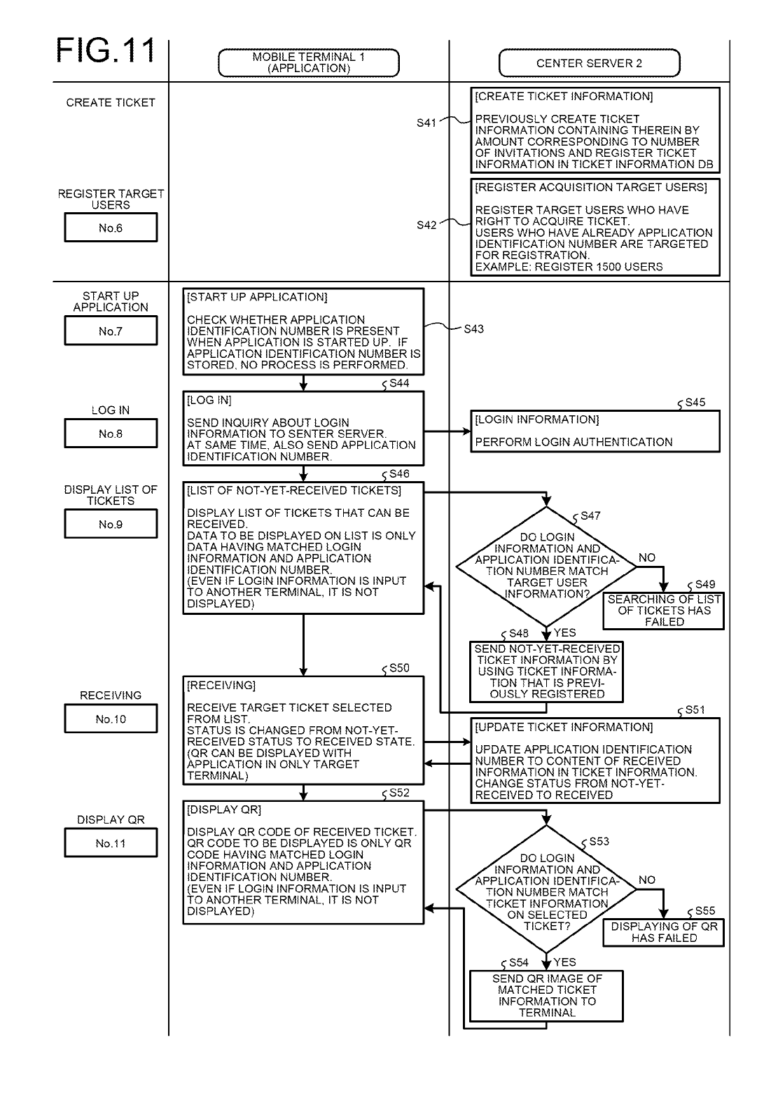

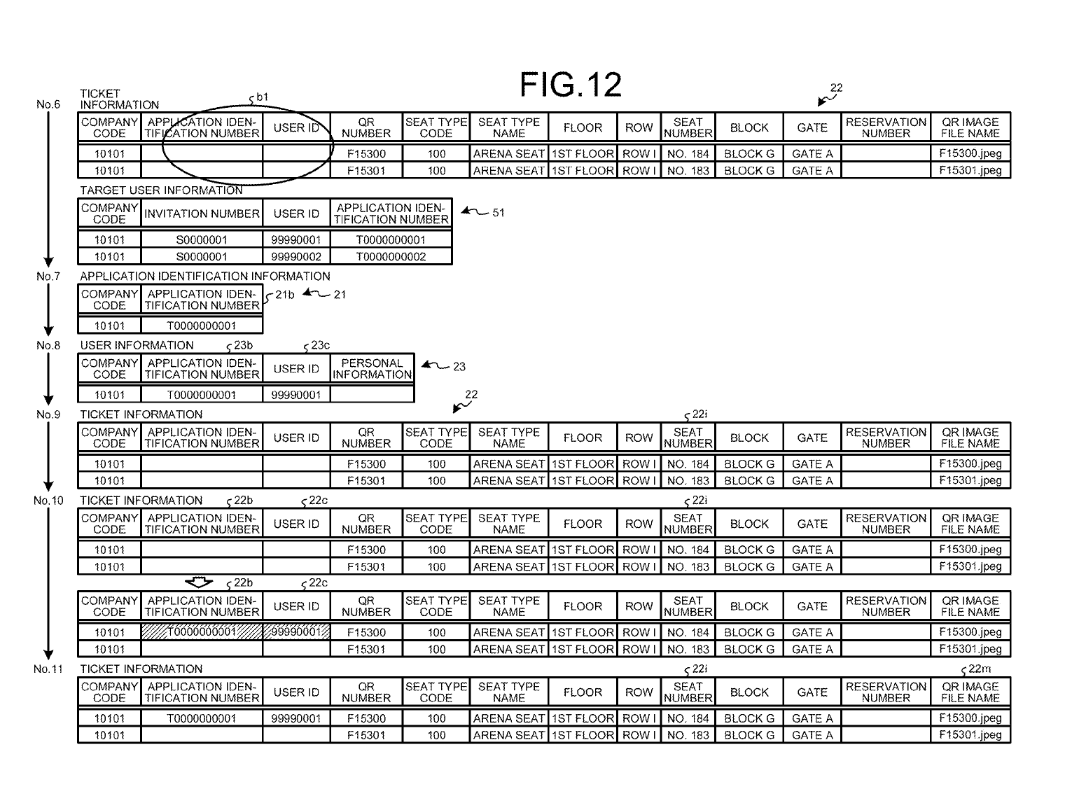

In the following, the sequence of a QR displaying process will be described by appropriately using the content of data in the various DBs. FIG. 11 is a schematic diagram illustrating the sequence of the QR displaying process according to the second embodiment. Furthermore, in below, a description will be given by appropriately using the records stored in the ticket information DB 22, the application identification information DB 21, the user information DB 23, and the target user information DB 51 illustrated in FIG. 12.

First, the center server 2 previously creates ticket information that contains therein by an amount corresponding to the number of invitations and registers the ticket information in the ticket information DB 22 (Step S41). Then, the center server 2 registers target persons who have a right to acquire the ticket in the user information DB 23. The target persons are targeted for users who have already application identification numbers (Step S42). At this point, an application identification number and the user ID (b1) have not been set in the ticket information that is registered in the ticket information DB 22 (see No. 6 of FIG. 12). Furthermore, users who can acquire tickets are registered in the target user information DB 51. Furthermore, in the sequence described below, a description will be given of displaying QR for a user with the user ID of “99990001”. It is assumed that the application identification number of the application 10 that is set in the mobile terminal 1 used by the user is “T0000000001”.

In this state, the application 10 is started up in the mobile terminal 1. Then, the application 10 refers to the storage area and checks whether the application identification number is present. If the application identification number is stored, the application 10 does not perform any process (Step S43). In this example, because the application identification number is stored in the application 10, the application 10 does not perform any process. At this point, in the application identification information DB 21 in the center server 2, the application identification number 21b of the application 10 has already been set (No. 7 of FIG. 12).

Subsequently, when the login information is input to the mobile terminal 1, the ticket display requesting unit 12 sends, to the center server 2, the input login information and the application identification number that is stored in the storage area and then inquires about login authentication (Step S44). The login information includes therein, for example, the user ID.

In the center server 2, if the ticket displaying unit 32A receives an inquiry about the login authentication, the ticket displaying unit 32A performs the login authentication by using the login information and the application identification number (Step S45). In this example, in the user information DB 23, “99990001” is set as the user ID 23c and “T0000000001” is set as the application identification number 23b (No. 8 of FIG. 12). Accordingly, by using the user information DB 23, the ticket displaying unit 32A performs the login authentication by using the application identification information and the login information as a key and the login authentication is successful.

Subsequently, in the mobile terminal 1, when the ticket display requesting unit 12 receives a notification indicating that the login authentication is successful, in order to display the list of the tickets that can be received, the ticket display requesting unit 12 sends a display request for the list of the tickets that can be received (Step S46). The login information and the application identification number are included in the display request for the list of the tickets that can be received.

In the center server 2, the ticket displaying unit 32A receives the display request for the list of the tickets that can be received. Then, the ticket displaying unit 32A determines whether the login information and the application identification number included in the display request match any target user information stored in the target user information DB 51 (Step S47). If it is determined that the login information and the application identification number included in the display request match any target user information stored in the target user information DB 51 (Yes at Step S47), the ticket displaying unit 32A performs the following process. Namely, if not-yet-received ticket information is present in the ticket information stored in the ticket information DB 22, the ticket displaying unit 32A returns the target ticket information to the mobile terminal 1 (Step S48).

In contrast, if it is determined that the login information and the application identification number do not match any of the target user information stored in the target user information DB 51 (No at Step S47), the ticket displaying unit 32A determines that the searching of the list of the tickets has failed (Step S49). Then, the ticket displaying unit 32A does not return the ticket information to the mobile terminal 1.

In the following, a description will be given with reference to No. 9 of FIG. 12. In the ticket information DB 22, two pieces of the ticket information indicating the seat number 22i of “No. 184” and “No. 183” have not been received. Accordingly, the ticket displaying unit 32A returns the not-yet-received ticket information to the mobile terminal 1 that is the request source. Namely, the ticket displaying unit 32A displays the list of the not-yet-received ticket information on the monitor of the mobile terminal 1 that is the request source.

Subsequently, in the mobile terminal 1, ticket information is selected by a user from among the pieces of ticket information displayed on the monitor, the ticket receiving unit 13A sends a receipt request for the ticket in order to receive the ticket indicated by the selected ticket information (Step S50). In the receipt request for the ticket, in addition to the login information and the application identification number, the selected ticket information is included.

In the center server 2, when the ticket information updating unit 32B receives the receipt request for the ticket from the application 10, for the ticket information DB 22, the ticket information updating unit 32B updates the application identification number and the user ID to that stored in the ticket information on the ticket requested by the receipt request. Then, for the ticket requested by the receipt request, the ticket information updating unit 32B changes the status displayed on the monitor of the mobile terminal 1 from the not-yet received state to the received state (Step S51). In the following, a description will be given with reference to No. 10 of FIG. 12. If it is assumed that the seat number of the ticket requested by the receipt request from the application 10 is “No. 184”, the application identification number 22b that is associated with the seat number 22i indicated by “No. 184” in the ticket information DB 22 is set to “T0000000001”. The user ID 22c that is associated with seat number 22i indicated by “No. 184” in the ticket information DB 22 is set to “99990001”.

Subsequently, in the mobile terminal 1, when the ticket requested by the receipt request is received, the QR display requesting unit 13B sends a display request for the QR code in order to display the QR code of the received ticket (Step S52). In the display request for the QR code, in addition to the login information and the application identification number, the ticket information on the received ticket is included.

In the center server 2, the QR displaying unit 33 receives the display request for the QR code. Then, the QR displaying unit 33 determines whether the login information and the application identification number included in the request match login information and the application identification number that are stored in the ticket information DB 22 and that are related to the ticket information on the received ticket (Step S53). If it is determined that the login information and the application identification number included in the request match login information and the application identification number that are stored in the ticket information DB 22 and that are related to the ticket information on the received ticket (Yes at Step S53), the QR displaying unit 33 performs the following process. Namely, the QR displaying unit 33 returns a QR image of the ticket information on the received ticket to the mobile terminal 1 (Step S54).

In contrast, if it is determined that the login information and the application identification number included in the request do not match login information and the application identification number that are stored in the ticket information DB 22 and that are related to the ticket information on the received ticket (No at Step S53), the QR displaying unit 33 determines that the displaying of the QR image has failed (Step S55) and does not return the QR image to the mobile terminal 1.

In the following, a description will be given with reference to No. 11 of FIG. 12. If it is assumed that the seat number of the received ticket indicated by the ticket information is “No. 184”, the QR displaying unit 33 returns a QR image of the QR image file name 22m “F15300.jpeg” that is associated with the seat number 22i to the mobile terminal 1 that is the request source. Namely, the QR displaying unit 33 displays the QR image of the ticket information on the received ticket on the monitor of the mobile terminal 1 that is the request source.

Advantage of the Second Embodiment

According to the second embodiment, the center server 2 stores, in the ticket information DB 22, the associated information in which the application identification number of the application 10 that is set in the mobile terminal 1 is associated with the ticket information. Then, if the center server 2 associates multiple pieces of the ticket information with multiple different application identification numbers, the center server 2 performs the following process. Namely, on the basis of a request from the application 10, the center server 2 associates the application identification number that is input by the application 10 with the ticket information in which an application identification number has not been associated from among the pieces of the ticket information in the ticket information DB 22 and updates the ticket information DB 22. With this configuration, because the center server 2 associates the application identification number requested by the application 10 with the ticket information and updates the ticket information DB 22, the application 10 is associated with the ticket information, thereby the applications 10 can be identified. Consequently, the ticket information associated with the application 10 that is set in the mobile terminal 1 does not leak out to the other mobile terminals.

Furthermore, according to the second embodiment, the center server 2 determines whether the application identification number acquired by the display request for an electronic ticket matches one of the application identification numbers that is associated with the associated information. If the determination result indicates that the application identification number matches one of the application identification numbers associated with the associated information, the center server 2 sends the electronic ticket that is associated with the matched application identification number to the mobile terminal 1 in which the application 10 is set. With this configuration, the center server 2 can identify the application 10 that corresponds to the request source by using the application identification number, the center server 2 can send the electronic ticket associated with the application identification number to the valid application 10. In other words, because the center server 2 can identify, by using the application identification number, the mobile terminal 1 in which the application 10 that is the request source is set, the center server 2 can send an electronic ticket that is associated with the application identification number to the valid mobile terminal 1.

Furthermore, according to the second embodiment, if the application identification number acquired by the display request for an electronic ticket does not match any of the application identification numbers associated with the associated information, the center server 2 does not send an electronic ticket to the mobile terminal 1 that is the send source of the display request. With this configuration, by using application identification number, the center server 2 can identify the application 10 that is the request source, the center server 2 can prevent an electronic ticket from being sent to the invalid application 10. In other words, because the center server 2 can identify, by using the application identification number, the mobile terminal 1 in which the application 10 that is the request source is set, the center server 2 can prevent an electronic ticket from being sent to the invalid mobile terminal 1.

Furthermore, the center server 2 can be implemented by installing the functions of units described above, such as the control unit 30 and the storing unit 20, in an information processing apparatus, such as a known personal computer or a workstation.

Furthermore, in the embodiments, the code that is used for authentication at the time of admission is described as a QR code. However, the code that is used for authentication at the time of admission is not limited to the QR code. For example, a one-dimensional bar code may also be used. Furthermore, a two-dimensional bar code of visible information that can be electronically displayed on the mobile terminal 1 belonging to a user may also be used. Accordingly, the application 10 may also be an application that can display a ticket on the mobile terminal 1 or an application that is used to display visible information.

The components of each device illustrated in the drawings are not always physically configured as illustrated in the drawings. In other words, the specific shape of a separate or integrated device is not limited to the drawings; however, all or part of the device can be configured by functionally or physically separating or integrating any of the units depending on various loads or use conditions. For example, the ticket display requesting unit 12 and the QR display requesting unit 13 may also be integrated as a single unit. In contrast, the application identification information creating unit 31 may also be separated by dividing it into a creating unit that creates an application identification number and a returning unit that returns the created application identification number. Furthermore, the storing unit 20, such as the ticket information DB 22 or the like, may also be an external device of the center server 2 and connected via a network.

According to an aspect of an embodiment of the present invention, an advantage is provided in that ticket information can be sent to a valid mobile terminal.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information management apparatus comprising:
a processor; and
a memory, wherein the processor executes:
allocating, on the basis of communication with a terminal, identification information to an application that is set in the terminal;
receiving an acquisition request for electronic information via the application;
creating associated information in which identification information on the electronic information is associated with the identification information on the application; and
sending, on the basis of the identification information on the application acquired by the acquisition request and the associated information, the electronic information associated with the identification information on the application.

2. The information management server according to claim 1, wherein the creating includes creating the associated information in which identification information on the electronic information that is associated with authentication information that is acquired by the acquisition request is associated with the identification information on the application that is acquired by the acquisition request.

3. The information management apparatus according to claim 2, wherein, when an authentication request is received from a user via the application and the user is authenticated, the creating includes creating associated information in which identification information on the application acquired by the authentication request is associated with electronic information that is not associated with the identification information on the application from among predetermined multiple pieces of the electronic information.

4. The information management apparatus according to claim 1, wherein
the sending includes
determining whether the identification information on the application acquired by the acquisition request matches any of the identification information on applications associated with the associated information, and
sending, when the result of the determination performed at the determining indicates that the identification information on the application matches any of the identification information on the applications associated with the associated information, the electronic information associated with the identification information on the matched application to the terminal in which the application is set.

5. The information management apparatus according to claim 4, wherein, when the identification information on the application does not match any of the identification information on the applications associated with the associated information, the sending does not send any of the electronic information to the terminal in which the application is set.

6. The information management apparatus according to claim 1, the processor further executes:
sending the identification information allocated at the allocating to the terminal in which the application is set.

7. A terminal comprising:
a processor; and
a memory, wherein the processor executes:
acquiring, via communication with a apparatus, identification information that is related to and allocated to an application that is set in the terminal; and
requesting, by using the identification information on the application acquired at the acquiring, the apparatus to acquire electronic information that is associated with a user who uses the terminal.

8. The terminal according to claim 7, the processor further executes:
retaining the identification information on the application acquired at the acquiring in a storage area of the application that is set in the terminal.

9. An information management system comprising:
multiple terminals; and
an information management apparatus, wherein
each of the terminals includes
an acquiring unit that acquires, via communication with the information management apparatus, identification information that is related to and allocated to an application that is set in one of the terminals, and
a requesting unit that requests, by using the identification information on the application acquired by the acquiring unit, the apparatus to acquire electronic information that is associated with a user who uses the terminal, and
the information management apparatus includes
an allocating unit that allocates, on the basis of communication with the terminal, identification information to the application that is set in the terminal,
a receiving unit that receives an acquisition request for the electronic information via the application,
a creating unit that creates associated information in which identification information on the electronic information is associated with the identification information on the application, and
a sending unit that sends, on the basis of the identification information on the application acquired by the acquisition request and the associated information, the electronic information that is associated with the identification information on the application.
